(19) United States
(12) Patent Application Publication
(10) Pub. No.: US 2010/0296819 A1
(43) Pub. Date: Nov. 25, 2010

(54) Optical Receivers and Communication Systems

(76) Inventors: Joseph M. Kahn, San Carlos, CA (US); Ezra Ip, Plainsboro, NJ (US)

Correspondence Address: CRAWFORD MAUNU PLLC, 1150 NORTHLAND DRIVE, SUITE 100, ST. PAUL, MN, 55120, US

(21) Appl. No.: 12/428,816

(22) Filed: Apr. 23, 2009

Related U.S. Application Data
(60) Provisional application No. 61/047,608, filed on Apr. 24, 2008.

(51) Int. Cl. H04B 10/06; H04B 10/00

(52) U.S. Cl. 398/158; 398/208

(57) ABSTRACT

Optical communications systems and methods transmit signals through an optical medium at a rate associated with a symbol interval. Receivers are communicatively coupled to the optical medium, and receive the signals. The received signals are processed using a plurality of filters. Each filter is used sequentially, one per symbol interval, during a sequence of consecutive symbol intervals. In certain exemplary embodiments, the tap spacing is K/M times the symbol interval, where K is the number of filters used, and M is an integer greater than K.

### RELATED DOCUMENTS

This patent document claims the benefit, under 35 U.S.C. §119(e), of U.S. Provisional Patent Application Ser. No. 61/047,608 filed on Apr. 24, 2008, and entitled “Optical Receivers and Communication Systems;” this patent document and the Appendices filed in the underlying provisional application are fully incorporated herein by reference.

### FEDERALLY SPONSORED RESEARCH OR DEVELOPMENT

This invention was made with Government support under contract W911-QX-06-C-0101 awarded by the Defense Advanced Research Projects Agency. The U.S. Government has certain rights in this invention.

### FIELD OF THE INVENTION

The present invention relates to systems and methods of optical communication where received optical signals are processed at an oversampled rate using filters.

### BACKGROUND

Optical communications (e.g., transmitted via optical fibers or other media) has become a common way to transmit digital signals. For example, the use of single-mode optical fiber can be found in long haul terrestrial and trans-oceanic systems, while the use of multimode optical fiber can be found in a variety of applications, particularly local and campus area networks found at universities, schools, hospitals, businesses and factories.

Chromatic dispersion (CD) and polarization-mode dispersion (PMD) are two important linear distortions that affect the performance of optical systems. In traditional receivers that employ direct detection, the phase of the optical E-field is lost, making exact equalization of the channel by a linear filter impossible. Coherent detection attempts to circumvent this problem by combining the received signal with a local oscillator (LO) laser and by using photodetection to downconvert it into a baseband electrical output that is proportional to the optical E-field. The resulting signal can then be sampled and processed by digital signal processing (DSP) algorithms.

In principle, any linear channel distortion can be compensated in DSP by a digital receiver operating at one sample per symbol. Prior to sampling, the receiver employs an analog matched filter, which is matched to the convolution between the transmitted pulse shape and the channel impulse response. In practice however, taking only one sample per symbol renders a system susceptible to sampling time error. A fractionally spaced equalizer (FSE) can implement the matched filter and equalizer as a single unit and can compensate for sampling time errors, provided that the baseband signal is sampled above the Nyquist rate. The FSE is widely employed in other areas of digital communications such as mobile radio and digital subscriber lines.

Conventional fractionally spaced equalizers (FSE) are designed to work at speeds where samplers (e.g., analog-to-digital converters) sample input signals at a rate that is an integer multiple (M) of the symbol rate (Rs), i.e., M×Rs. Signal processing may then be performed using a single filter with a tap spacing T=(K/M)×Ts, where Ts=1/Rs, where K is an integer. Recent experiments in coherent optical transmission have used an oversampling rate M=2 and K=1, corresponding to a filter tap spacing T=(½)×Ts, for CD compensation.

In single-mode fiber (SMF) communication, PMD causes a statistical time-varying differential group delay (DGD) between the two principal states of polarization (PSP). The impact of PMD on the performance of a symbol-rate equalizer is similar to the sampling time error. Thus, it should be possible to use a polarization diversity coherent receiver in conjunction with an FSE in suppressing any arbitrary amount of PMD-induced group delay since PMD is a linear effect.

### SUMMARY

In accordance with certain embodiments, the present invention is directed to receivers for use in optical communications systems in which an optical signal is sent through an optical medium at a rate associated with a symbol interval, such receivers being communicatively coupled to the optical medium to receive the signal.

In some embodiments, the receivers include a sampling circuit to sample the received signal at a rate greater than the symbol rate, and a plurality of filters with tap spacing less than a symbol interval being arranged for processing the received signal, each being used sequentially, one per symbol interval, during a sequence of consecutive symbol intervals. In certain exemplary embodiments within this class of receivers, the tap spacing is K/M times the symbol interval, where K is the number of filters used, and M is an integer greater than K.

In certain embodiments, the receivers include a plurality of analog filters with tap spacing less than a symbol interval being arranged for processing the received signal, each being used sequentially, one per symbol interval, during a sequence of consecutive symbol intervals. In certain exemplary embodiments within this class of receivers, the tap spacing is K/M times the symbol interval, where K is the number of filters used, and M is an integer greater than K.

In accordance with other embodiments, the present invention is directed to optical communications systems that include an optical medium, a transmitter for transmitting an optical signal through the optical medium at a rate associated with a symbol interval, and a receiver communicatively coupled to the optical medium to receive the signal. The receivers include a plurality of filters with tap spacing less than a symbol interval being arranged for processing the received signal, each being used sequentially, one per symbol interval, during a sequence of consecutive symbol intervals. The optical medium may be free space, and in some embodiments the optical medium may include an optical fiber.

In accordance with certain other embodiments, the present invention is directed to methods for processing a signal received over an optical medium of an optical communications system in which the optical signal is sent at a rate associated with a symbol interval. Such methods include processing the received signal using a plurality of filters with tap spacing less than a symbol interval in sequence, one per symbol interval, during a sequence of consecutive symbol intervals.

The above overview is not intended to describe each illustrated embodiment or every implementation of the present invention.

### BRIEF DESCRIPTION OF THE DRAWINGS

The invention may be more completely understood in consideration of the included description in connection with the accompanying drawings, in which:

FIG. 1 schematically indicates an optical communications system in accordance with certain embodiments of the present invention;

FIG. 2 schematically indicates optical signal processing in accordance with certain embodiments of the present invention;

FIGS. 3A and 3B respectively illustrate a dual-polarization coherent optical receiver and a carrier-recovery system, also in accordance with example embodiments of the present invention;

FIGS. 4A and 4B respectively illustrate an example of maximum tolerable chromatic (FIG. 4A) and PMD (FIG. 4B) differential group delay vs. equalizer length for 16-QAM transmission with 2 dB power penalty at an input SNR of 20 dB per symbol, also according to the present invention; and

FIGS. 5A and 5B respectively illustrate a schematic perspective of a dual-polarization coherent optical system employing a homodyne detection receiver, and an equivalent baseband model of the same system, also according to the present invention.

While the invention is amenable to various modifications and alternative forms, examples thereof have been shown by way of example in the drawings and will be described in detail. It should be understood, however, that the intention is not to limit the invention to the particular embodiments shown and/or described. On the contrary, the intention is to cover all modifications, equivalents, and alternatives falling within the spirit and scope of the invention.

### DETAILED DESCRIPTION

The present invention is believed to be applicable to a wide variety of optical communications applications, including those that are directed to optical fibers as the communication medium (e.g., single-mode fibers, multi-mode fibers), and those that are directed to different types of detection mechanisms (e.g., coherent detection, direct detection).

In particular, the present invention is believed to be applicable to optical communications systems, receivers for optical communication systems, and optical communication methods in which an optical signal is sent through an optical medium at a rate associated with a symbol interval. In accordance with certain embodiments, the receiver includes a plurality of filters with tap spacing less than the symbol interval being arranged for processing the received signal. Each filter is used sequentially, one per symbol interval, during a sequence of consecutive symbol intervals. In certain exemplary embodiments, the tap spacing is K/M times the symbol interval, where K is the number of filters used, and M is an integer greater than K.

Certain embodiments of the present invention may be implemented to reduce the sampling rate, allowing accommodation of very high symbol transmission speeds. For example, implementations of the present invention can provide sampling rates of 1.5 times the symbol rate whereas conventional FSE techniques might use higher oversampling rates. In certain embodiments, the oversampling rate is equal to an integer multiple of the symbol rate divided by the number of distinct filters used in the signal processing, where the integer multiple is greater than the number of filters.

For purposes of illustration, the following notation may be used in which the symbol rate is Rs, the symbol interval is Ts=1/Rs, and the oversampling ratio is a ratio of two integers M/K, where M is greater than or equal to K. Signal processing is performed using filters having tap spacing T=(K/M)×Ts, which is less than or equal to Ts. In an exemplary embodiment, M=3 and K=2, with K also being equal to the number of distinct filters. As such, the signal is sampled at an oversampling rate of (M/K)×Rs (e.g., equal to 1.5×Rs for M=3 and K=2). In the general case, one filter is used for one symbol interval, then the next filter is used for the next symbol interval, and so forth until all K filters have been used, at which point the K filters sequence is cycled again. For K 2, one filter is used for the even symbol intervals, and the other is used for the odd symbol intervals.

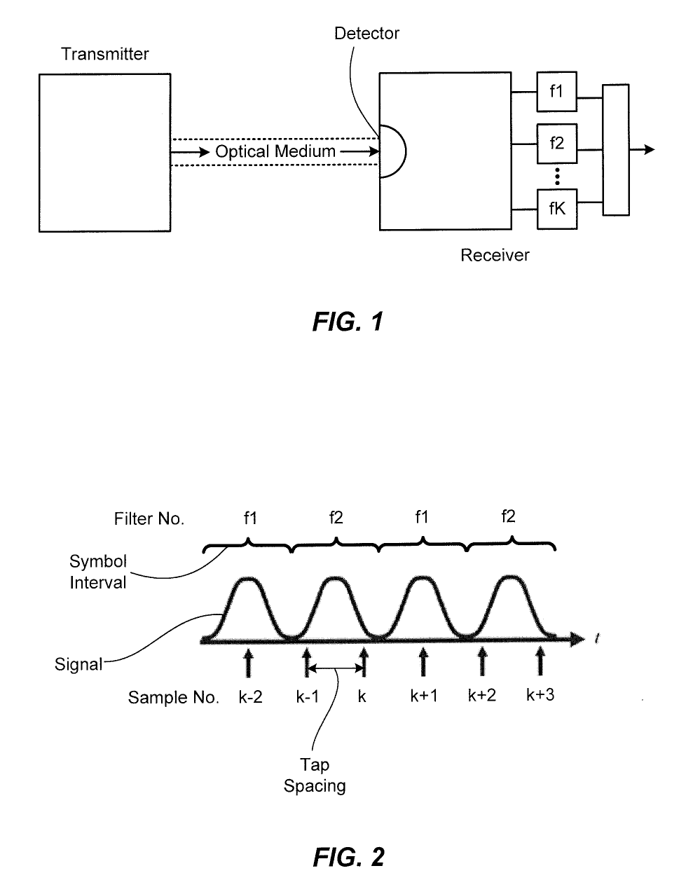

With reference to FIG. 1, there is shown an example optical communications system that includes a transmitter and a receiver. The transmitter transmits optical signals at a symbol rate over an optical medium, which may include free space, a single-mode optical fiber, a multi-mode optical fiber, and so forth. The receiver receives the signal, for example using coherent detection or direct detection. The receiver includes an optical detector (e.g., a photodetector) and a plurality of filters to process the received signal. The receiver may include a sampling circuit to sample the received signal. The filters may be digital filters or analog filters, for example that utilize tapped delay lines. The receiver may also include amplifiers to amplify the optical signal before detection by the detector, and/or amplify the electrical signal after detection by the detector. Various compensation elements and signal conditioning may also be applied in the case that analog filters are used. Upon processing by the filters, the signal symbols are recombined, for example by use of a multiplexer.

The signal is processed using filters with a tap spacing that is less than the symbol interval. In exemplary embodiments, the tap spacing is greater than half the symbol interval. A number (K) of filters, f1 through fK, are used in sequence to process the signal, one filter being used for each symbol interval. In exemplary embodiments, the tap spacing is K/M times the symbol interval, where M is an integer greater than the number of filters, K. The signal processing using the filters may compensate for chromatic dispersion, polarization mode dispersion, modal dispersion, timing skew, or the like.

With reference to FIG. 2, an exemplary embodiment is shown where two filters, f1 and f2, are used, and where the tap spacing is ⅔ times the symbol interval (i.e., 3/2 oversampling ratio). As shown, the sampling time relative to the symbol peak differs for the odd symbols (processed with filter f1) and the even symbols (processed with filter f2). For example, the odd symbols are sampled near the symbol peak, and the even symbols are sampled twice, with the samples straddling the symbol peak.

For a specific example, aspects of the present invention can be implemented to form part of a coherent receiver where digital feedforward carrier recovery techniques can tolerate significantly more laser phase noise (e.g., relative to tolerance levels of phase-locked loops). In this technical environment, coherent detection enables near-ideal compensation of linear channel impairments by linear digital filters, and sampling at twice the symbol rate is sufficient.

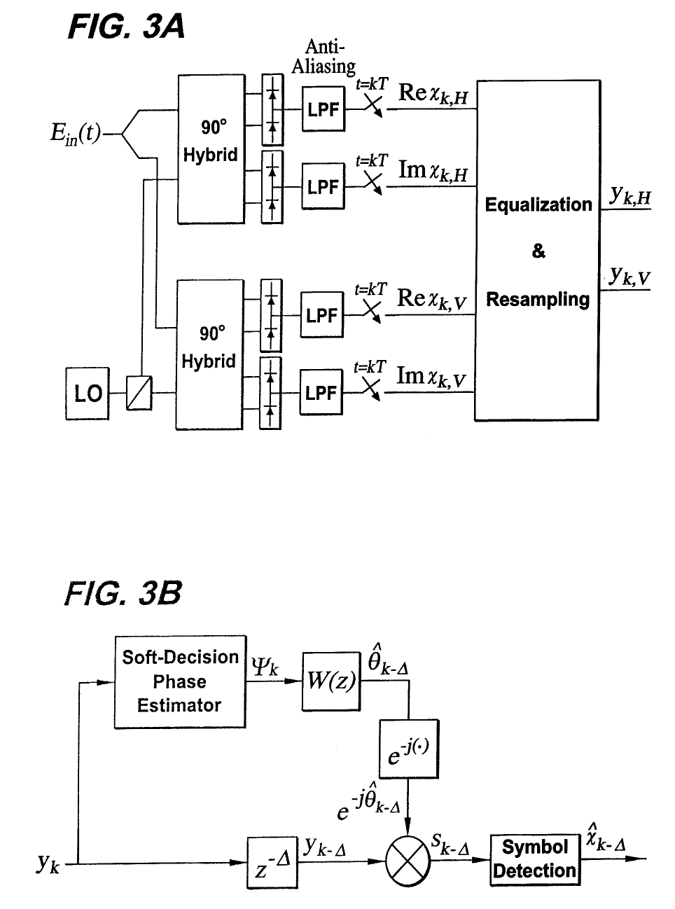

FIGS. 3A and 3B show a dual-polarization coherent optical receiver and a carrier-recovery system, respectively. With reference to FIG. 3A, the received signal is combined with a local oscillator laser through two 90-degree hybrids and four balanced photodetectors, yielding signals that are proportional to the in-phase and quadrature components of the electrical fields in the two received polarizations. These signals are passed through anti-aliasing filters and sampled at rate 1/T=M/KT_{S}, where T_{S} is the symbol period, and K/M is the oversampling ratio.

These types of optical detection can provide compensation of linear channel impairments. In principle, a coherent receiver can equalize any linear channel distortion exactly, including chromatic dispersion (CD) and polarization mode dispersion (PMD). An important design consideration is the oversampling ratio. In theory, optimum performance is achievable using only one sample per symbol provided matched filtering is used, and sampling occurs at the optimum times. In practice, symbol-rate sampling is susceptible to sampling time error and differential group delay between the polarization modes. Consequently, CD and PMD can only be partly corrected, even using an infinite number of filter taps in the digital equalizer filter. A fractionally-spaced equalizer (FSE) allows completely compensation of any arbitrary amount of CD and PMD, provided sampling is performed above the Nyquist rate. Owing to the impossibility of generating pulses that are strictly band-limited, it has been discovered that in practice, an FSE operating at two samples per symbol (K/M=2) is sufficient to compensate CD and PMD with less that 2 dB power penalty for NRZ and for 33%, 50% and 67% RZ pulses; as discussed in, Digital Equalization of Chromatic Dispersion and Polarization Mode Dispersion, E. IP and J. M. Kahn, Journal of Light Wave Technol., Vol. 25, No. 8, August 2007.

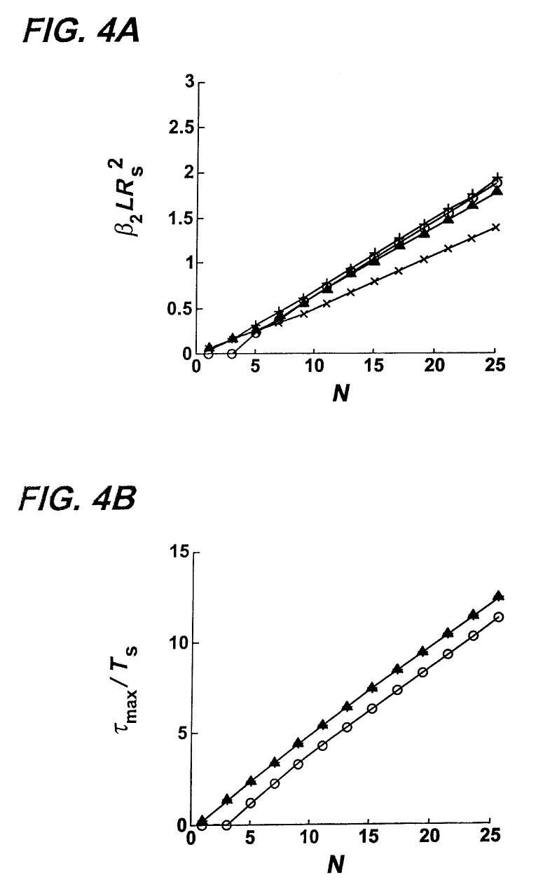

For a maximum tolerable threshold, FIGS. 4A and 4B show the correctable amounts of chromatic (FIG. 4A) and PMD (FIG. 4B) as a function of N, which denotes the number of filter taps per pair of input-output polarizations. More specifically, the illustration includes PMD differential group delay versus equalizer length for 16-QAM transmission with 2 dB power penalty at an input SNR of 20 dB per symbol; these results are for a sampling rate twice the symbol rate (the graphical symbols including ‘o’ for NRZ transmission, ‘x” for 33% RZ, ‘Δ’ for 50% RZ and ‘+’ for denoting 67% RZ). We assumed the receiver anti-aliasing filter has a 5-th order Bessel characteristic with a 3-dB cutoff frequency of 0.4/T. As determined, increasing N allows more dispersion to be corrected, with a linear relationship between the tolerable CD and filter length N that approximately follows:

$${B}_{2} {LR}_{s}^{2} ( \frac{M}{K} ) \approx 1.15 N ,$$

where β₂L is the CD of the fiber and RS=1/T_{S} is the symbol rate. For first-order PMD, the correctable amount of PMD different group delay τₘₐₓ versus N approximately follows:

N=τₘₐₓM/KTₛ.

In a feedforward structure, coherent detection also allows carrier recovery to be performed digitally. No optical or electrical phase-locked loop (PLL) is required. With reference to the above discussion regarding compensation for linear channel impairments, the carrier recovery structure shown in FIG. 3B, taking the input to be a stream of equalized symbols, (in one polarization) that have been re-sampled at one sample per symbol, the soft-decision phase estimator computes a rough estimate of the instantaneous carrier phase using either a non-decision-aided (NDA) algorithm for xPSK transmission, or a decision-directed (DD) algorithm when transmitting a non-constant-envelope signaling format like QAM. Since laser phase noise has temporal correlation through a Wiener process, the optimum hard-decision estimator is a minimum mean-square error (MMSE) linear filter. To perform carrier recovery, the input symbols are de-rotated by the estimated carrier phase \hat{θ}ₖ, and then detection follows. Our linearized phase noise model allows determination of the optical filter coefficients and the resulting mean square phase error, which determines the power penalty for a given system. Assuming a power penalty of 0.5 dB at a target bit-error ratio (BER) of 10⁻⁹, the maximum tolerable laser beat linewidths for various signaling formats are shown in Table 1. The left column shows the maximum T_{bl} for a coherent receiver employing a PLL as described in, Carrier Synchronization for 3- and 4-bit-per Symbol Optical Transmissions, E. Ip and J. M. Kahn, J. of Lightwave Technol., Vol. 23, No. 12, December 2005. Δν and T_{b} are the beat linewidth and bit period, respectively. Feedforward carrier recovery is four times more tolerant to phase noise than a PLL for 4- and 8-QAM, and ten times more tolerant to phase noise for 16-QAM. For this example, Table 1 below shows maximum tolerable beat linewidths (Δν and T_{b}) for 4-QAM, 8-QAM and 16-QAM for a BER of 10⁻⁹.

| | Feedforward | PLL-based |
|---|---|---|
| | Carrier Recovery | Receiver |
| 4-QAM | 1.5 × 10⁻⁴ | 3.5 × 10⁻⁵ |
| 8-QAM | 7.7 × 10⁻⁵ | 1.8 × 10⁻⁵ |
| 16-QAM | 1.3 × 10⁻⁵ | 1.3 × 10⁻⁶ |

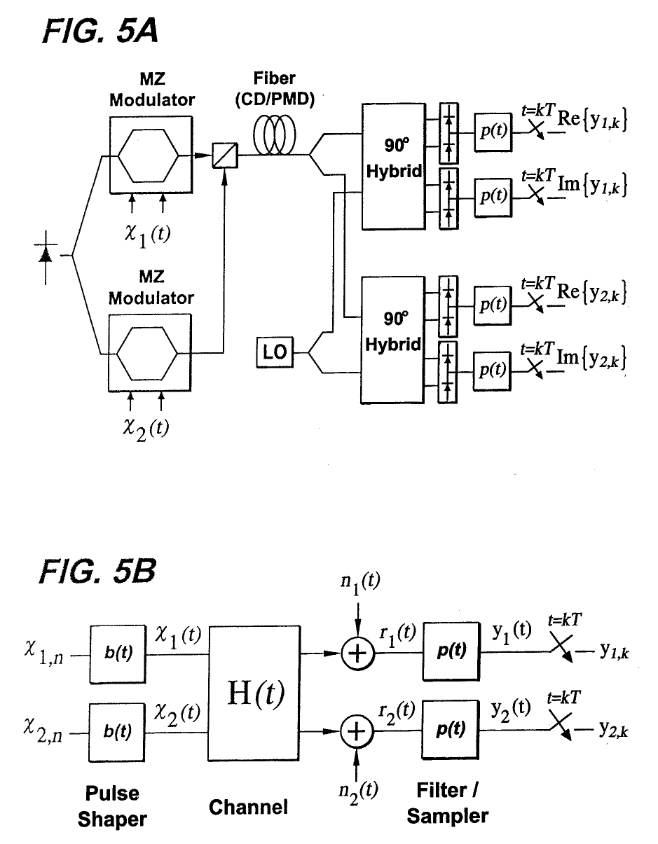

For a more specific example, an aspect of the present invention is discussed as a polarization-diversity receiver. The canonical model of a dual-polarization (polarization-multiplexed) coherent optical system employing a homodyne receiver is shown in FIG. 5A. The transmitter consists of two Mach-Zehnder (MZ) modulators, where each modulator is capable of generating symbols from any arbitrary signal constellation. The two optical data streams, which are polarized in orthogonal directions, are then combined using a polarization beam splitter. After passing through an SMF, the received signal is split in two paths that are mixed with the LO through a network consisting of two 90° hybrids and, then, is coherently detected using four balanced photodetectors. The electrical outputs are baseband signals corresponding to the I and Q associated with the polarizations parallel and orthogonal to the LO. These signals are then passed through low-pass antialiasing filters having an impulse response p(t) and are sampled at a rate of 1/T using analog-to-digital converters (ADCs).

The dual polarization coherent receiver has a baseband equivalent model that is shown in FIG. 5B. The transmitted signals in the two input polarizations are of the form

$${x}_{j} ( t ) = {\sum }_{n} {x}_{j , n} b ( t - {nT}_{s} )$$

where x_{j,n} is the nth symbol transmitted in the jth polarization of the fiber, and b(t) is the transmitted pulse shape, which is assumed to be the same for both channels.

For further information (including canonical modeling, an analysis applied to a polarization-multiplexed and surprising performance results), reference may be made to Appendix B of the above-cited underlying Provisional Application, and the article, Digital Equalization of Chromatic Dispersion and Polarization Mode Dispersion, (authored by the inventors of the instant patent document), J. of Lightwave Technol., Vol. 25, No. 8, August 2007.

The skilled artisan would appreciate and understand the terminology used herein. For example, Chromatic Dispersion relates to the properties of fiber and in which the speed an optical pulse travels depends on its wavelength as caused by factors including material dispersion, wave guide dispersion and profile dispersion. The net effect is that if an optical pulse contains multiple wavelengths (colors), then the different colors will travel at different speeds and arrive at different times, smearing the received optical signal. Modal dispersion is a distortion mechanism occurring in multimode fibers and other waveguides, in which the signal is spread in time because the propagation velocity of the optical signal is not the same for all modes (other names for this include multimode distortion, multimode dispersion, modal distortion, intermodal distortion, intermodal dispersion, and intermodal delay distortion). Multi-mode optical fiber (multimode fiber or MM fiber or simply fiber) is an optical fiber type often used for communicating over shorter distances (e.g., from within a building to across a campus). In certain applications, multimode links have data rates of 10 Mbit/s to 10 Gbit/s over link lengths of up to 600 meters which would be more than sufficient for many premises applications. Polarization is a property of transverse waves that describes the orientation of the oscillations in the plane perpendicular to the wave's direction of travel. Polarization mode dispersion (PMD) is a form of modal dispersion where two different polarizations of light in a waveguide, which normally travel at the same speed, travel at different speeds due to random imperfections and asymmetries, causing random spreading of optical pulses. Symbol rate as measured in symbols-per-second (Hertz), is the gross bit rate, inclusive of channel coding overhead, divided by the number of bits transmitted in each symbol. Oversampling is the process of sampling a signal with a sampling frequency significantly higher than twice the bandwidth or highest frequency of the signal being sampled. An oversampled signal is said to be oversampled by a factor of β, defined as

$$β {=}^{def} \frac{{f}_{s}}{2 B}$$

where fₛ is the sampling frequency, and B is the bandwidth or highest frequency of the signal (the Nyquist rate being 2B).

The present invention has been described in connection with the above-described embodiments and the referenced publications and Appendices (which form part of this document and are incorporated in their entirety), and for a variety of applications including without limitation optical-fiber systems, mobile radio and digital subscriber lines. For example, in connection with certain aspects of the present invention, coherent detection enables nearly ideal compensation of any linear channel impairments using linear filters. For NRZ and RZ pulses, sampling at twice the symbol rate is sufficient. With regards to other aspects, feedforward carrier recovery methods provide much greater tolerance to laser phase noise than traditional demodulation using a phase-locked loop. Those skilled in the art will recognize that changes may be made thereto without departing from the spirit and scope of the present invention. Such changes may include, for example, the implementation of one or more approaches as described in the publications and Appendices, including approaches described in the references listed therein and practical-implementation approaches (e.g., constructing the above-referenced components and modules using DSP algorithms, programmable computer circuits, semi-programmable circuits such as PLDs, and/or discrete analog and digital circuitry). These and other approaches as described in the contemplated claims below characterize aspects of the present invention.

What is claimed is:

1. For use in an optical communications system in which an optical signal is sent through an optical medium at a rate associated with a symbol interval, a receiver communicatively coupled to the optical medium and receiving the signal, the receiver comprising a plurality of filters with tap spacing less than the symbol interval being arranged for processing the received signal, each being used sequentially, one per symbol interval, during a sequence of consecutive symbol intervals.

2. The receiver of claim 1, wherein the received signal is sampled and the filters are digital filters.

3. The receiver of claim 1, wherein the received signal is sampled and the filters are discrete-time analog filters.

4. The receiver of claim 1, wherein the filters are analog filters.

5. The receiver of claim 1, wherein the tap spacing is greater than half the symbol interval.

6. The receiver of claim 1, wherein the tap spacing is K/M times the symbol interval, where K is the number of filters used, and M is an integer greater than K.

7. The receiver of claim 1, wherein the signal is received using coherent detection.

8. The receiver of claim 1, wherein the signal is received using direct detection.

9. The receiver of claim 1, wherein processing the received signal compensates for chromatic dispersion.

10. The receiver of claim 1, wherein processing the received signal compensates for polarization mode dispersion.

11. The receiver of claim 1, wherein processing the received signal compensates for modal dispersion.

12. The receiver of claim 1, wherein processing the received signal compensates for timing skew.

13. The receiver of claim 1, wherein the optical medium includes a single-mode optical fiber.

14. The receiver of claim 1, wherein the optical medium includes a multi-mode optical fiber.

15. The receiver of claim 1, wherein the optical medium includes free space.

16. The receiver of claim 1, wherein the plurality of filters are two distinct digital filters, the optical medium includes a single-mode optical fiber, the tap spacing is ⅔ times the symbol interval, and wherein processing the signal compensates for at least one of timing skew, chromatic dispersion and polarization mode dispersion.

17. An optical communications system comprising:
an optical medium;
a transmitter for transmitting an optical signal through the optical medium at a rate associated with a symbol interval;
a receiver, communicatively coupled to the optical medium and receiving the signal; and
a plurality of filters with tap spacing less than the symbol interval being arranged for processing the received signal, each being used sequentially, one per symbol interval, during a sequence of consecutive symbol intervals.

18. The optical communications system of claim 17, wherein the receiver includes a sampling circuit that samples the received signal at a rate greater than the symbol rate.

19. The optical communications system of claim 17, wherein the optical medium includes a single-mode optical fiber.

20. The optical communications system of claim 17, wherein the optical medium includes a multi-mode optical fiber.

21. The optical communications system of claim 17, wherein the optical medium includes free space.

22. The optical communications system of claim 17, wherein the tap spacing is greater than half the symbol interval.

23. The optical communications system of claim 17, wherein the tap spacing is K/M times the symbol interval, where K is the number of filters used, and M is an integer greater than K.

24. For use in an optical communications system in which an optical signal is sent through an optical medium at a rate associated with a symbol interval, a method for processing a signal received over the optical medium, the method comprising processing the received signal using a plurality of filters with tap spacing less than the symbol interval in sequence, one per symbol interval, during a sequence of consecutive symbol intervals

25. The method of claim 24, wherein the tap spacing is K/M times the symbol interval, where K is the number of filters used, and M is an integer greater than K.
